(19) United States
(12) Patent Application Publication
(10) Pub. No.: US 2025/0273012 A1
(43) Pub. Date: Aug. 28, 2025

(54) INFORMATION PROCESSING DEVICE, INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Takahiro TOIZUMI, Tokyo (JP); Yuho SHOJI, Tokyo (JP)

(73) Assignee: NEC Corporation, Minato-ku, Tokyo (JP)

(21) Appl. No.: 18/857,498

(22) PCT Filed: Jul. 21, 2022
(86) PCT No.: PCT/JP2022/028345

§ 371 Date: Oct. 17, 2024

(51) Int. Cl. G06V 40/18; G06V 10/40; G06V 10/74

(52) U.S. Cl. CPC G06V 40/193; G06V 10/40; G06V 10/761

(57) ABSTRACT

A feature vector of each of multiple regions, cut out from a region of an eye of a target included in an acquired image, is extracted. The weight of similarity is identified for each of the multiple regions that is calculated based on the feature vector of each of the multiple regions and a feature vector relating to each of corresponding regions that is pre-stored for the target. A similarity between feature vectors of the eye of the target included in the acquired image and pre-stored feature vectors of the eye of the target is calculated by using the feature vector of each of the multiple regions and the weights identified for those feature vectors.

### TECHNICAL FIELD

The present disclosure pertains to an information processing device, an information processing system, an information processing method, and a storage medium.

### BACKGROUND ART

There is an ensemble estimation method in which multiple estimators are generated and those multiple different estimators are used to output prescribed estimation results with respect to inputs. In this ensemble estimation method, each of the multiple estimators performs estimations by using an estimation model obtained by learning using the same or different data sets. At the time of calculation of estimation results, the estimation results of each estimator are combined and are defined as the overall estimation results.

Related technologies are disclosed in Non-Patent Document 1 to Non-Patent Document 4. Non-Patent Document 1 discloses technology (bagging) in which multiple sub-data sets are prepared from a training data set by sampling in which redundancy is permitted, and these sub-data sets are used to train individual weak learners.

Non-Patent Document 2 discloses learning technology (boosting) in which, when training a certain weak learner, weights of loss with respect to training data are determined from the output results from other learners. With this method, for example, new learners are trained so as to boost the ability to identify input data for which other learners have yielded erroneous estimation results.

Non-Patent Document 3 discloses learning technology in which, when training weak learners, partial images obtained by randomly cutting out portions of original images are used.

Non-Patent Document 4 discloses technology in which there are weak learners in which iris images are input and weak learners in which periocular images are input, and the respective results are combined to output estimation results.

Additionally, Patent Document 1 discloses, as related technology, a method for authenticating a target by using multiple biometric characteristics, wherein the characteristics of iris patterns, iris colors, and corneal surfaces are used.

### CITATION LIST

### Patent Documents

Patent Document 1: Japanese Unexamined Patent Application, First Publication No 2018-514046

### Non-Patent Documents

Non-Patent Document 1: L. Breiman, “Bagging predictors”, Machine Learning, 24, 123-140, 1996.
Non-Patent Document 2: R. E. Schapire, “A brief introduction to Boosting”, Proceedings of the Sixteenth International Joint Conference on Artificial Intelligence, 1999.
Non-Patent Document 3: B. Cheng, W. Wu, D. Tao, S. Mei, T. Mao and J. Cheng, “Random Cropping Ensemble Neural Network for Image Classification in a Robotic Arm Grasping System”, IEEE Transactions on Instrumentation and Measurement, vol. 69, no. 9, pp. 6795-686 September 2020, doi: 10.1109/TIM.2020.2976420.
Non-Patent Document 4: Oishi, S., Ichino, M., Yoshiura, H., “Fusion of iris and periocular user authentication by AdaBoost for mobile devices”, 2015 IEEE International Conference on Consumer Electronics (ICCE), 9-12 Jan. 2015, Piscataway, NJ, USA, pp. 428-429 (2015).

### SUMMARY OF INVENTION

### Technical Problem

An objective of the present disclosure is to provide an information processing device, an information processing system, an information processing method, and a storage medium with the objective of improving on the conventional art documents mentioned above.

### Solution to Problem

According to a first example embodiment disclosed herein, an information processing device is provided with feature vector extracting means for extracting a feature vector of each of multiple regions cut out from an acquired image including an eye of a target; weight identifying means for identifying a weight of similarity for each of the multiple regions calculated based on the feature vector of each of the multiple regions and a feature vector relating to each of corresponding regions that are pre-stored for the target; and similarity calculating means for calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

According to a second example embodiment disclosed herein, an information processing system is provided with feature vector extracting means for extracting a feature vector of each of multiple regions cut out from a region of an eye of a target included in an acquired image; weight identifying means for identifying a weight of similarity for each of the multiple regions calculated based on the feature vector of each of the multiple regions and a feature vector relating to each of corresponding regions that are pre-stored for the target; and similarity calculating means for calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

According to a third example embodiment disclosed herein, an information processing method includes extracting a feature vector of each of multiple regions cut out from a region of an eye of a target included in an acquired image; identifying a weight of similarity for each of the multiple regions calculated based on the feature vector of each of the multiple regions and a feature vector relating to each of corresponding regions that are pre-stored for the target; and calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

According to a fourth example embodiment disclosed herein, a storage medium stores a program for causing a computer in an information processing device to function as feature vector extracting means for extracting a feature vector of each of multiple regions cut out from a region of an eye of a target included in an acquired image; weight identifying means for identifying a weight of similarity for each of the multiple regions calculated based on the feature vector of each of the multiple regions and a feature vector relating to each of corresponding regions that are pre-stored for the target; and similarity calculating means for calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

### BRIEF DESCRIPTION OF THE DRAWINGS

FIG. 1 is a block diagram illustrating the configuration of an authentication device in a first example embodiment.

FIG. 2 is a diagram illustrating a summary of a landmark detection process in the first example embodiment.

FIG. 3 is a first diagram illustrating a summary of a normalization process in the first example embodiment.

FIG. 4 is a second diagram illustrating a summary of the normalization process in the first example embodiment.

FIG. 5 is a third diagram illustrating a summary of the normalization process in the first example embodiment.

FIG. 6 is a diagram illustrating a summary of a region selection process in the first example embodiment.

FIG. 7 is a diagram indicating a processing flow for a feature vector recording process performed by the authentication device 1 in the first example embodiment.

FIG. 8 is a diagram indicating a processing flow for an authentication process performed by the authentication device 1 in the first example embodiment.

FIG. 9 is a first diagram indicating a summary of a weight identifying process in the first example embodiment.

FIG. 10 is a second diagram indicating a summary of a weight identifying process in the first example embodiment.

FIG. 11 is a block diagram of functions for generating a weight identifying model for recognition scores in the first example embodiment.

FIG. 12 is a diagram indicating a processing flow for generating a weight identifying model for recognition scores in the first example embodiment.

FIG. 13 is a block diagram illustrating the configuration of an authentication device 1 in a second example embodiment.

FIG. 14 is a diagram indicating a summary of a region selection process in a second example embodiment.

FIG. 15 is a diagram indicating a processing flow for a feature vector recording process performed by the authentication device 1 in the second example embodiment.

FIG. 16 is a diagram indicating a processing flow for an authentication process performed by the authentication device 1 in the second example embodiment.

FIG. 17 is a hardware configuration diagram of an authentication device.

FIG. 18 is a diagram illustrating the minimum configuration of the authentication device.

FIG. 19 is a diagram indicating a processing flow by the authentication device with the minimum configuration.

### EXAMPLE EMBODIMENT

Hereinafter, an authentication device according to one example embodiment of the present disclosure will be described in detail with reference to the drawings. The authentication device is one example embodiment of an information processing device.

### First Example Embodiment

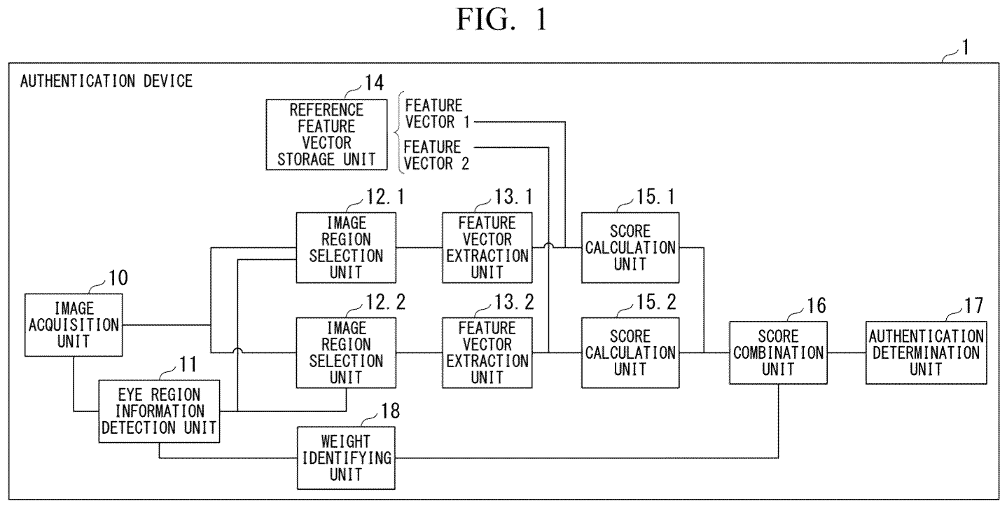

FIG. 1 is a block diagram illustrating the configuration of an authentication device 1 in a first example embodiment.

As illustrated in FIG. 1, the authentication device 1 is provided with an image acquisition unit 10, a landmark detection unit 11, image region selection units 12.1, 12.2, feature vector extraction units 13.1, 13.2, a reference feature vector storage unit 14, score calculation units 15.1, 15.2, a score combination unit 16, an authentication determination unit 17, and a weight identifying unit 18.

The image acquisition unit 10 acquires images including the iris of an eye and the area around the eye in an authentication target. The iris refers to the circular area with a pattern of eye muscle fibers surrounding the pupil. The muscle fiber patterns in irises have characteristics that are unique to individual people, and do not change very much. The authentication device 1 of the present example embodiment authenticates targets by using iris pattern information. This is called iris recognition. For example, the authentication device 1, during iris recognition, identifies the iris area from an image including an eye, and divides the iris area into multiple blocks. Furthermore, the authentication device 1 performs recognition by extracting and quantifying feature vectors in the respective blocks, and collating them with prestored iris feature vectors. The authentication device 1 may perform recognition by adding, to this iris recognition process, a process for further comparing brightness change information, in which the brightness changes with respect to adjacent blocks are coded for the respective blocks, with pre-stored brightness change information for the irises of multiple people.

The landmark detection unit 11 detects landmark information including position information, etc. regarding important ranges and landmark points set so as to allow prescribed sub-regions relating to the eyes to be selected from an acquired image. In the present disclosure, shapes such as pupil circles or iris circles and points indicating regions and position information of the pupils/irises or the eyelids are referred to as landmark information. The landmark information represents information including points and circles designed to allow regions such as the irises or the periocular to be extracted from eye images. The landmark information is not limited to points and circles, and may be element information, such as lines, ellipses, polygons, or Bezier curves. Additionally, the landmark information may be shape information made by combining these respective elements.

The image region selection units 12.1, 12.2 select sub-regions including an iris region based on the landmark information detected by the landmark detection unit 11. More specifically, the image region selection unit 12.1 selects, as a sub-region a1, an overall circular region including a pupil region inside an outer circle c1 of an iris. Alternatively, the image region selection unit 12.1 may select, as a sub-region a1, a donut-shaped region surrounded by the outer circle c1 and the inner circle c2 of the iris. The image region selection unit 12.2 selects a sub-region a2 including an eyeball and regions around the eye (such as the eyelids). The image region selection units 12.1, 12.2 will be referred to, collectively, as the image region selection units 12.

The feature vector extraction unit 13.1 (13.2) extracts feature vectors f1 (f2) from the sub-region a1 (a2) selected by the image region selection unit 12.1 (12.2). In the case in which the sub-regions a1, a2 include the pupil region, just the iris region without the pupil region may be cut out to extract the feature vectors f1, f2 corresponding respectively to the sub-regions a1, a2. The feature vectors are vector values representing the features of eyes, including the iris, required for performing iris recognition. The feature vector extraction units 13.1, 13.2 will be referred to, collectively, as feature vector extraction units 13.

The reference feature vector storage unit 14 stores reference feature vectors indicating the feature vectors of targets, such as people, that have been registered in advance. A reference feature vector is, for example, an M-th reference feature vector among multiple reference feature vectors of people registered in advance before recognition, the feature vector having been extracted by the feature vector extraction units 13.1, 13.2 and recorded in the reference feature vector storage unit 14 during a feature vector registration process performed in advance.

The score calculation unit 15.1 (15.2) uses the feature vectors f1 (f2) extracted by the feature vector extraction unit 13.1 (13.2) and the reference feature vectors f1 (f2) stored in the reference feature vector storage unit 14 to calculate scores SC1 (scores SC2), which are recognition scores SC for the respective sub-regions. The recognition scores SC mentioned here are the similarity between the reference feature vectors f1, f12 and corresponding feature vectors that have been registered in advance, required for performing iris recognition. The score calculation units 15.1, 15.2 will be referred to, collectively, as score calculation units 15.

The score combination unit 16 uses the scores SC1, SC2 obtained from the score calculation units 15.1, 15.2 to calculate a combined recognition score TSC. When calculating the combined recognition score TSC, the score combination unit 16 uses weights of the recognition scores SC regarding the respective sub-regions calculated by the weight identifying unit 18 to calculate the combined recognition score TSC.

The authentication determination unit 17 performs an authentication determination based on the combined recognition score TSC obtained from the score combination unit 16.

The weight identifying unit 18 identifies weights for the feature vectors in which the similarity is to be calculated, based on the feature vectors obtained from the features of the respective sub-regions and the feature vectors regarding the corresponding regions pre-stored for a person who is a recognition target.

The target on which the authentication device 1 of the present example embodiment performs authentication may be a human or an animal, such as a dog or a snake.

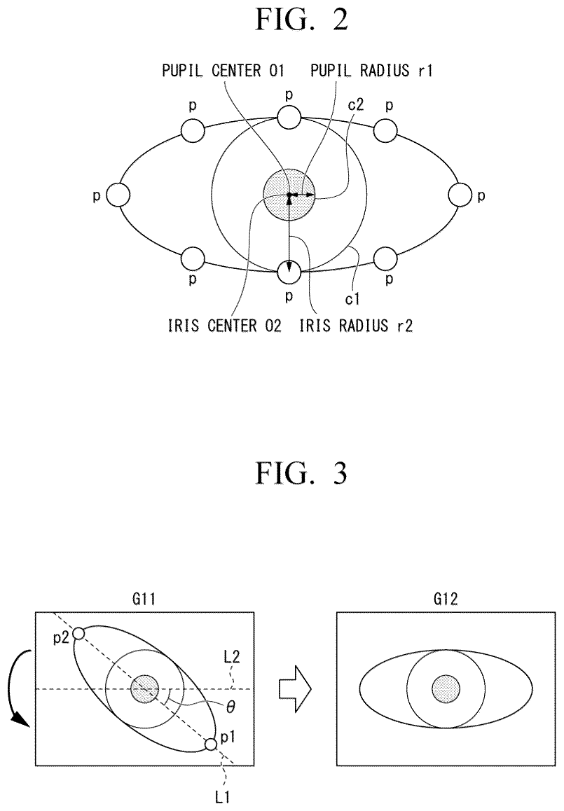

FIG. 2 is a diagram illustrating a summary of the landmark detection process.

The landmark detection unit 11 may detect the coordinates of points p in an outline of the eyelids included in an acquired image, the central coordinate O1 of the circle of the pupil, the central coordinate O2 of the circle of the iris, the radius r1 of the pupil, the radius r2 of the iris, etc., and may calculate a vector composed of the values thereof as landmark information. The coordinates of the points p on the outline of the eyelids (upper eyelid, lower eyelid) included in the acquired image may be relative coordinates having a prescribed position on the eye as the origin. The prescribed position may be a point at the inner corner of the eye or the outer corner of the eye, or may be the midpoint on a line connecting the points of the inner corner of the eye and the outer corner of the eye, or the like.

FIG. 3 is a first diagram illustrating a summary of a normalization process.

The image acquisition unit 10 identifies a point p1 at the outer corner and a point p2 at the inner corner of an eye appearing in an acquired image (G11), determines the angle θ formed between a straight line L1 passing through those points and the horizontal direction L2 in the image, and uses the formed angle θ to generate an image (G12) obtained by rotationally converting the image so that the straight line L1 connecting the point at the outer corner of the eye with the point at the inner corner of the eye is aligned with the horizontal direction L2 in the image. The generation of this rotationally converted image (G12) is one mode of image normalization.

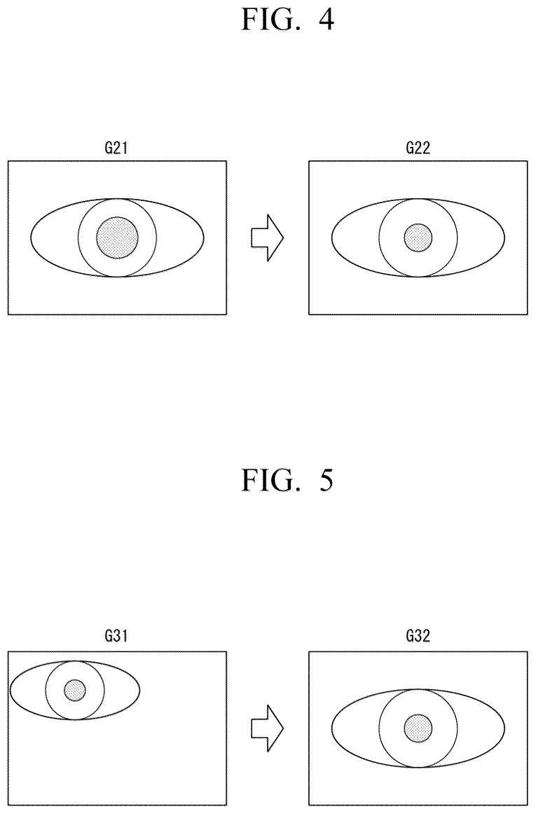

FIG. 4 is a second diagram illustrating a summary of a normalization process.

The image acquisition unit 10 identifies the diameter of the pupil or the diameter of the iris in the eyeball of an eye appearing in an acquired image (G21) and generates an image (G22) in which the image is reduced or enlarged so that the diameter of the pupil or the iris becomes a prescribed value. At this time, the image acquisition unit 10 may generate the reduced or enlarged image by identifying the number of pixels equivalent to the length of the diameter of the iris and the number of pixels equivalent to the length of the diameter of the pupil with reference to the coordinates of the center of the circle of the pupil, and by performing image processing, such as geometric conversion, so that the ratio between the number of pixels equivalent to the length of the diameter of the iris and the number of pixels equivalent to the length of the diameter of the pupil is fixed. The generation of this reduced or enlarged image (G22) is one mode of image normalization.

FIG. 5 is a third diagram illustrating a summary of a normalization process.

The image acquisition unit 10 generates an image (G32) in which the position of an eye appearing in an acquired image (G31) has been moved to the center of the image. At this time, the image acquisition unit 10 generates the image (G32) converted so that the position of the coordinates of the center of the circle of the iris becomes a prescribed position in the image, or so that the diameter of the pupil or the iris becomes a prescribed value. The generation of this converted image (G32) is one mode of image normalization. At this time, the image acquisition unit 10 may generate the converted image (G32) by performing image processing, such as geometric conversion, so that the number of pixels equivalent to the length of the radius of the iris with reference to the coordinates of the center of the circle of the iris is fixed. The generation of this converted image (G32) is one mode of image normalization.

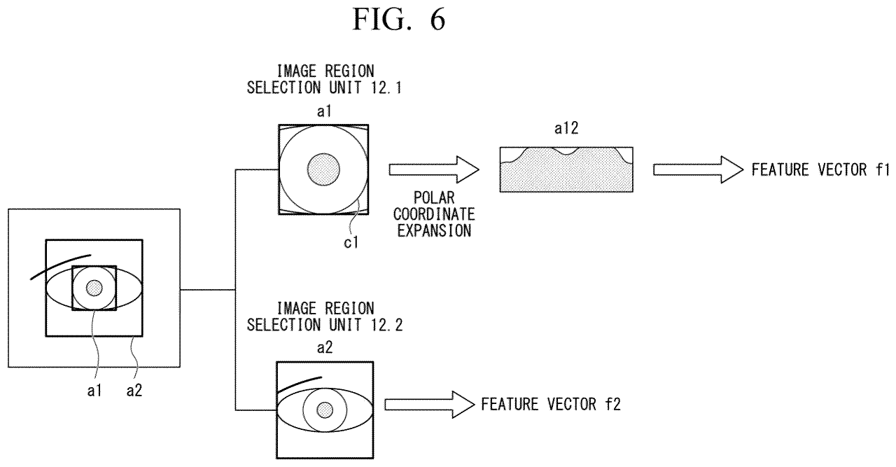

FIG. 6 is a diagram illustrating a summary of a region selection process.

The image region selection units 12, after one or more of the processes explained using FIG. 3, FIG. 4, and FIG. 5 above have been performed, cut out images of prescribed sub-regions based on eye landmark information. As illustrated in FIG. 6, the image region selection unit 12.1 selects a rectangular sub-region a1 including the circular region of the outer circle c1 of the iris based on the central position of the iris detected by the landmark detection unit 11. Additionally, the image region selection unit 12.2 selects a rectangular sub-region a2 including the eyeball and the regions around the eye based on the central position of the iris detected by the landmark detection unit 11. The sub-region a1 is one mode of a region including at least the iris region and not including regions around the eye (for example, the eyelids, the outside corner of the eye, the inside corner of the eye, etc.). The sub-region a2 is one mode of a region including both the iris region and regions around the eye. The regions of the selected sub-regions a1, a2 may be shapes other than rectangular (for example, circular or other shapes). The image region selection unit 12.1 generates an image a12 generated by polar coordinate expansion of the iris included in the sub-region a1.

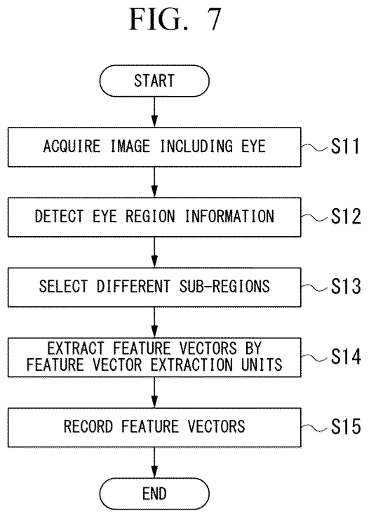

FIG. 7 is a diagram indicating the processing flow in a feature vector recording process performed by the authentication device 1 in the first example embodiment. Next, the feature vector recording process in the authentication device 1 in the first example embodiment will be explained with reference to FIG. 7.

In a feature vector recording process performed in advance, a certain person makes the authentication device 1 acquire a facial image including the eyes of that person, or a partial facial image indicating a portion of the face including at least the eyes. The authentication device 1 may use a prescribed camera to capture an image of the person, and may acquire an image generated at the time of the image capture. The image acquisition unit 10 acquires an image including an eye of a person (step S11). Said image includes at least one one eye or both eyes of the person. Additionally, the pupil and the iris of the eye appear in said image. The image acquisition unit 10 outputs the image to the landmark detection unit 11 and the image region selection units 12.1, 12.2.

The landmark detection unit 11 detects landmark information based on the acquired image (step S12). The landmark detection unit 11 may calculate, from the acquired image, landmark information represented by a vector including numerical values for the central coordinates and the radius of the iris circle. As explained using FIG. 2, the landmark detection unit 11 may generate landmark information regarding the eye represented by a vector using points on an outline of the eyelids of the eye included in the acquired image, the central coordinates of the circle of the pupil, the central coordinates of the circle of the iris, the radius of the pupil, the radius of the iris, the coordinates of outlines of the eyelids (upper eyelid, lower eyelid), etc.

For example, the landmark detection unit 11 may output, as the landmark information, a vector representing numerical values of the radius of the pupil and the central position of the circle of the pupil, or positional coordinates of points on the eyelids, in addition to the numerical values of the central position of the circle of the iris and the radius of the circle of the iris. The landmark detection unit 11 may calculate, as the landmark information, a vector including the central coordinates of the outer circle c1 of the iris, the radius of the outer circle c1 of the iris, the coordinates of the outer corner of the eye, and the coordinates of the inner corner of the eye.

The landmark detection unit 11 may, for example, be composed of a recurrent neural network. The recurrent neural network may include multiple convolution layers and multiple activation layers, and may extract the landmark information in the acquired image. In the case in which the landmark detection unit 11 is constructed as a neural network, a neural network with any structure may be used as long as the relationship between the input and output is not changed. For example, as neural network structures, those similar to structures such as VGG, ResNet, DenseNet, SETNet, MobileNet, and EfficientNet can be mentioned. However, structures other than the above may also be used. The landmark detection unit 11 may be an image processing function that is not composed of a neural network. The landmark detection unit 11 may use the images after the conversion processes (normalization) explained using FIG. 3, FIG. 4, and FIG. 5 have been performed to generate eye landmark information. As the radius of the iris circle included in the landmark information, the information before normalization may be used. The landmark detection unit 11 outputs the landmark information to the image region selection units 12.1, 12.2.

The image region selection units 12.1, 12.2 acquire images input from the image acquisition unit 10 and acquire landmark information input from the landmark detection unit 11. The image region selection units 12.1, 12.2 respectively use the images and the landmark information to generate normalized images as explained with FIG. 3, FIG. 4, and FIG. 5, and select different sub-regions as illustrated in FIG. 6 (step S13). That is, the image region selection unit 12.1 selects the sub-region a1 and outputs said sub-region a1 to the feature vector extraction unit 13.1. The image region selection unit 12.2 selects the sub-region a2 and outputs said sub-region a2 to the feature vector extraction unit 13.2.

The feature vector extraction units 13.1, 13.2 perform, on the acquired sub-region images, for example, extraction of feature vectors after having performed image preprocessing, such as, brightness histogram normalization for converting the brightnesses of the respective pixels in an image so as to match the median value or the mean value in a histogram of brightnesses of the respective pixels with a prescribed brightness, masking processes on areas other than the iris circle, polar coordinate expansion with the center of the iris circle as the origin, and iris rubber sheet expansion using the iris circle and the pupil circle (step S14). The feature vector extraction unit 13.1 takes an image of the sub-region a1 as an input and extracts feature vectors f1. The feature vector extraction unit 13.2 takes an image of the sub-region a2 as an input and extracts feature vectors f2. The feature vector extraction units 13.1, 13.2 may be constructed, for example, by convolutional neural networks. The feature vector extraction units 13.1, 13.2 may learn models of feature vector extractors in advance by using labels of people and images of sub-regions selected in the image region selection units 12.1, 12.2. The feature vector extraction units 13 merely require to be estimators that use models capable of generating feature vectors with good performance, and may be other trained neural networks. Additionally, the feature vector extraction units 13.1, 13.2 may be processing functions for image processes that extract feature vectors not composed of neural networks.

The feature vector extraction units 13.1, 13.2 store the extracted feature vectors f1, f2 (reference feature vectors) in the reference feature vector storage unit 14 so as to be associated with a label, etc. of the person appearing in the image used in the feature vector recording process (step S15). As a result thereof, the feature vectors f1, f2 of two sub-regions of the different eyes of the person appearing in the image used in the feature vector recording process are respectively recorded in the reference feature vector storage unit 14.

The authentication device 1 may perform processes similar to those described above for both the left and right eyes appearing in an image, and may record the feature vectors f1 and the feature vectors f2 in the reference feature vector storage unit 14 so as to be further associated with a left-eye or a right-eye label. Additionally, the authentication device 1 may similarly perform feature vector recording processes using images of many people who are to be provided with prescribed services or processing functions by performing recognition, and may similarly record the feature vectors f1 and the feature vectors f2 in the reference feature vector storage unit 14. Due to the above processes, the description of the feature vector recording process performed in advance ends.

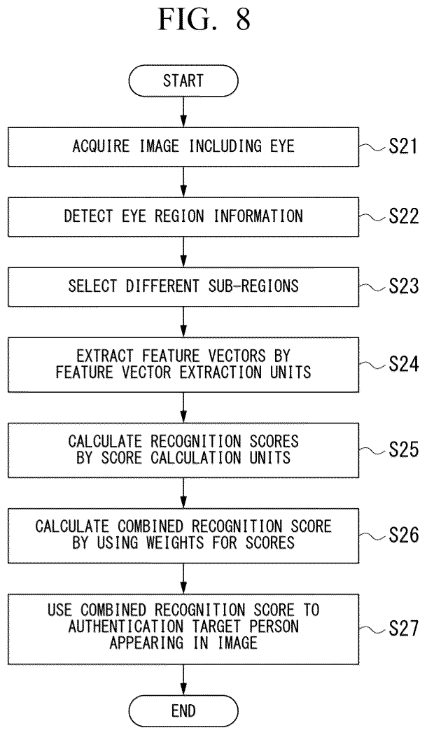

FIG. 8 is a diagram indicating the processing flow of the authentication process performed by the authentication device 1 in the first example embodiment. Next, the authentication process in the authentication device 1 in the first example embodiment will be explained with reference to FIG. 8.

The authentication device 1 may use a prescribed camera to capture an image of a person, and may acquire an image generated at the time of the image capture. The image acquisition unit 10 acquires an image including an eye of the person (step S21). Said image includes at least one eye or both eyes of the person. The image acquisition unit 10 outputs the image to the landmark detection unit 11 and the image region selection units 12.1, 12.2.

The landmark detection unit 11 detects landmark information of the eye based on the acquired image (step S22). This process is similar to the process in step S12 explained in the feature vector recording process mentioned above.

The image region selection units 12.1, 12.2 take images from the image acquisition unit 10 as inputs and take landmark information from the landmark detection unit 11 as inputs. The image region selection units 12.1, 12.2 respectively select different sub-regions (step S23) in a manner similar to the process in step S13 explained in the feature vector recording process. That is, the image region selection unit 12.1 selects the sub-region a1. The image region selection unit 12.1 selects the sub-region a2.

The feature vector extraction units 13.1, 13.2 extract feature vectors from the images of the selected sub-regions (step S24). This process is similar to the process in step S14 explained in the feature vector recording process mentioned above. The feature vector extraction unit 13.1 outputs the extracted feature vectors f1 and the feature vector extraction unit 13.2 outputs the extracted feature vectors f2 to respectively corresponding score calculation units 15.

The score calculation unit 15.1 acquires the feature vectors f1 extracted from the feature vector extraction unit 13.1 in the recognition process. The score calculation unit 15.2 acquires the feature vectors f2 extracted from the feature vector extraction unit 13.2 in the recognition process. The score calculation unit 15.1 acquires reference feature vectors (feature vectors f1) corresponding to one person extracted in the feature vector recording process recorded in the reference feature vector storage unit 14. The score calculation unit 15.2 acquires reference feature vectors (feature vectors f2) corresponding to one person extracted in the feature vector recording process recorded in the reference feature vector storage unit 14. The score calculation unit 15.1 and the score calculation unit 15.2 each use the feature vectors extracted in the recognition process and the feature vectors extracted in the feature vector recording process to calculate recognition scores SC (step S25). The recognition score SC calculated by the score calculation unit 15.1 is defined as the score SC1. Additionally, the recognition score calculated by the score calculation unit 15.2 is defined as the score SC2.

The score calculation units 15.1, 15.2 may calculate the score SC1 and the score SC2 by using, for example, the cosine similarity between the feature vectors extracted in the recognition process and the feature vectors extracted in the feature vector recording process. Additionally, the score calculation units 15.1, 15.2 may calculate the recognition scores SC by using an L2 distance function or an L1 distance function, etc., between the feature vectors extracted in the recognition process and the feature vectors extracted in the feature vector recording process. The score calculation units 15.1, 15.2 may determine whether each of the feature vectors are similar by making use of properties such as the feature vectors of data relating to the same person, such as the cosine similarity, the L2 distance function, the L1 distance function, etc. tending to be closer in distance.

The score calculation units 15.1, 15.2 may be constructed, for example, by neural networks. Additionally, the score calculation units 15.1, 15.2 may be functions for performing calculation processes for the recognition scores SC not composed of neural networks, and for example, may calculate the recognition scores SC by means of the Hamming distances between the feature vectors extracted in the recognition process and the feature vectors extracted in the feature vector recording process. The score calculation units 15.1, 15.2 output the calculated recognition scores SC to the score combination unit 16.

In parallel with the above-mentioned process, the weight identifying unit 18 calculates weights w for the recognition scores SC calculated by the score calculation units 15.1, 15.2. The weight for the score SC1 calculated by the score calculation unit 15.1 is defined as w1, and the weight of the score SC2 calculated by the score calculation unit 15.2 is defined as w2. The weight identifying unit 18 outputs the weights w1, w2 to the score combination unit 16. The details of the process in the weight identifying unit 18 will be explained below. The weights w1, w2 will be referred to, collectively, as the weights w.

The score combination unit 16 uses the score SC1, the score SC2, the weight w1, and the weight w2 to calculate a combined recognition score TSC (step S26). The score combination unit 16 calculates the combined recognition score TSC, for example, by adding the values obtained by multiplying the score SC1 and the score SC2 with the respectively corresponding weights w1, w2 (TSC=SC1*w1+SC2*w2). In this equation, “*” represents multiplication and “+” represents addition. Additionally, the score combination unit 16 may calculate the combined recognition score TSC by using an estimation method using a support vector machine or a recurrent neural network taking the scores SC1, SC2 and the weights w1, w2 as inputs.

The score combination unit 16 may use, as the means for calculating the combined recognition score TSC, the average of the values obtained by multiplying weights w corresponding to the respective recognition scores SC, or a weighted average thereof. The score combination unit 16 may calculate the combined recognition score TSC by selecting the largest of the recognition scores SC of each individual person who is a recognition target. Additionally, the score combination unit 16 may be constructed, for example, from a neural net. Additionally, the score combination unit 16 may be a processing function not composed of a neural net, and may, for example use logistic regression or Ridge regression. The score combination unit 16 outputs the combined recognition score TSC to the authentication determination unit 17.

The authentication determination unit 17 acquires the combined recognition score TSC. The authentication determination unit 17 uses the combined recognition score TSC to perform authentication on the person who is the target appearing in the image (step S27). For example, when the combined recognition score TSC is equal to or higher than a threshold value, the authentication determination unit 17 determines that the person appearing in the image is a registered person, and outputs authentication success information. When the combined recognition score TSC is lower than the threshold value, the authentication determination unit 17 determines that the person appearing in the image is a non-registered person, and outputs authentication failure information. The authentication determination unit 17 may identify, in the reference feature vector storage unit 14, the reference feature vectors used for calculating the combined recognition score TSC with the highest value among the combined recognition scores TSC equal to or higher than the threshold value, and may identify the person appearing in the image based on the label of the person associated with those reference feature vectors. The authentication determination unit 17 may determine that authentication has failed in the case in which the difference between the combined recognition score TSC with the highest value and the combined recognition score TSC with the next highest value among the combined recognition scores TSC equal to or higher than the threshold value is equal to or lower than a prescribed threshold value.

The authentication device 1 may perform the above-mentioned process on both the left and right eyes of the target appearing in an acquired image, and the authentication determination unit 17 may determine that the target appearing in the image has been successfully authenticated in the case in which the combined recognition scores TSC for both eyes are equal to or higher than a threshold value.

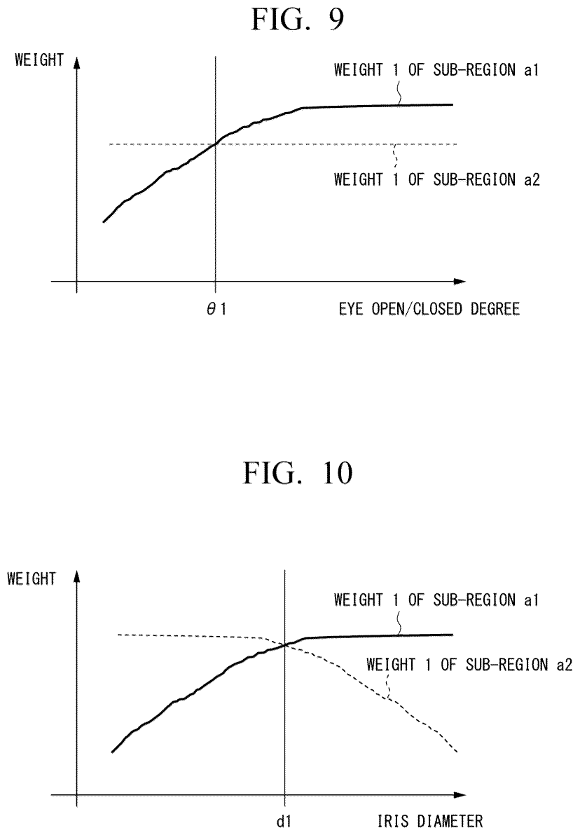

FIG. 9 is a first diagram illustrating a summary of a weight identifying process.

FIG. 10 is a second diagram illustrating a summary of a weight identifying process.

Next, the processing in the weight identifying unit 18 will be explained.

The weight identifying unit 18 calculates weights for the recognition scores SC calculated from the respective feature vectors in sub-region a1 and sub-region a2 based on the landmark information detected by the landmark detection unit 11. Specifically, the weight identifying unit 18 calculates the eye open/closed degree θ based on the distance (a height from the lower eyelid to the upper eyelid) h1 between intersection points p of a vertical line passing through the center O2 of the iris with the upper eyelid and the lower eyelid in an image normalized as in FIG. 3, FIG. 4, or FIG. 5. Said distance h1 is one mode of pixel information. The weight identifying unit 18 may calculate the ratio of the distance h1 to the diameter of the iris as the eye open/closed degree θ. In the case in which the diameter (iris diameter) of the iris is adjusted to be substantially the same value D by normalization, the weight identifying unit 18 may calculate the ratio of the distance h1 to the value D as the eye open/closed degree θ. The weight identifying unit 18 may calculate the eye open/closed degree θ by another method.

The weight identifying unit 18 may calculate the combined recognition score TSC by acquiring the eye open/closed degree θ and the iris diameter d of the iris from calculation results by the landmark detection unit 11, and when the eye open/closed degree θ is larger than a prescribed threshold value θ1, apply a large weight to the recognition score SC1 relating to the normalized iris circle region (sub-region a1), and apply a small weight to the recognition score SC2 relating to the region (sub-region a2) including the periocular (FIG. 9). In this case, even if the eye open/closed degree θ is larger than a threshold value θ1, the weight of the recognition score SC1 relating to the region of the circle of the iris, as indicated in FIG. 9, may be calculated to be slightly larger than the weight relating to the region including the periocular (FIG. 9). When the open/closed degree θ is smaller than the prescribed threshold value θ1, the weight identifying unit 18 may calculate the weight w2 for the sub-region a2 to be a value larger than the weight w1 for the sub-region a1 so that the combined recognition score TSC is computed by applying a larger weight w2 to the recognition score SC2 of the region (sub-region a2) including the periocular (FIG. 9). As a result thereof, since the larger the open/closed degree θ is, the more the iris will appear in an image, it is possible to calculate a combined recognition score TSC in which the features of the iris are enhanced. Additionally, since the smaller the iris diameter d is, the less the iris will appear in an image, it is possible to calculate a combined recognition score TSC in which the features in the periocular, such as skin and wrinkles around the eye, such as the eyelids, and the outer corner of the eye, are enhanced. In the example described above, which recognition score SC to be weighted more heavily was decided based on only the prescribed threshold value θ1. However, it is possible to set not just one, but multiple prescribed threshold values, and to calculate the weights of the recognition scores SC based on the relationship between those multiple threshold values and the eye open/closed degree θ. Additionally, the weights w of the respective sub-regions (iris and periocular) may be calculated by using functions of the eye open/closed degree θ without using a threshold value.

The weight identifying unit 18 may calculate the combined recognition score TSC by applying a larger weight to the recognition score SC1 relating to the normalized region (sub-region a1) of the circle of the iris when the iris diameter d is larger than the prescribed threshold value d1 (FIG. 10). The weight identifying unit 18 may calculate the combined recognition score TSC by applying a larger weight to the recognition score SC2 relating to the region (sub-region a2) including the periocular in the case in which the iris diameter d is smaller than a prescribed threshold value d1 (FIG. 10). As a result thereof, since the larger the iris diameter d is, the more the iris will appear in an image, it is possible to calculate a combined recognition score TSC in which the features of the iris are enhanced. Additionally, since the smaller the iris diameter d is, the less the iris will appear in an image, it is possible to calculate a combined recognition score TSC in which the features in the periocular, such as skin and wrinkles around the eye, such as the eyelids, and the outer corner of the eye, are enhanced. In the example described above, which recognition score SC to be weighted more heavily was decided based on only the prescribed threshold value d1. However, it is possible to set not just one, but multiple prescribed threshold values, and to calculate the weights of the respective recognition scores SC based on the relationship between those multiple threshold values and the iris diameter d. Additionally, the weights w of the respective sub-regions (iris and periocular) may be calculated by using functions of the iris diameter d without using a threshold value.

As these weights w, average values are calculated for the combined recognition scores TSC calculated by using images and score calculation models in the cases of various eye open/closed degrees θ and iris diameters d in advance, and values of weights w that maximize the recognition scores SC of the feature vectors of target people after calculating the combined recognition score TSC and values of weights w that minimize the recognition scores SC of the feature vectors of other people are extracted.

Furthermore, the weight identifying unit 18 may identify the values of the weights w that were extracted in advance based on open/closed degrees θ and iris diameters d obtained from an image.

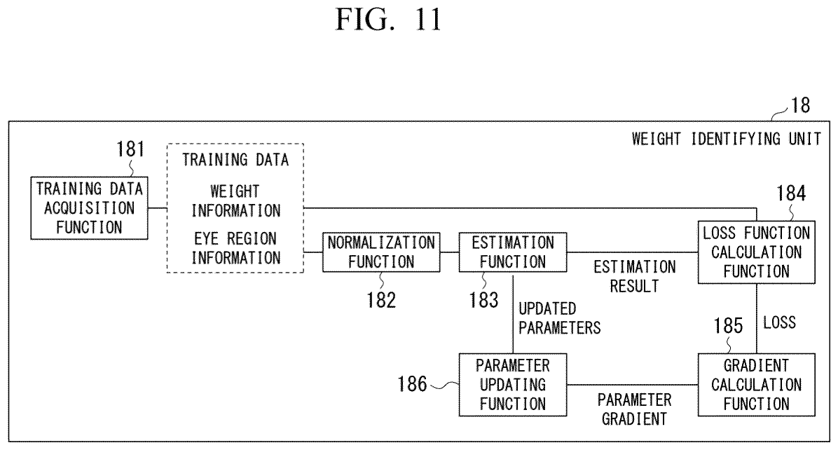

FIG. 11 is a block diagram of a function for generating a model for identifying weights for recognition scores.

The weight identifying unit 18 provides functions such as a training data acquisition function 181, a normalization function 182, an estimation function 183, a loss function calculation function 184, a gradient calculation function 185, and a parameter updating function 186. The weight identifying unit 18 may learn a identifying model for estimating weights w by using, as training data, combinations of labels for identifying individual people, weights w, and vectors representing the states of eye images, such as iris circles or pupil circles, or landmark points set so as to allow the selection of prescribed sub-regions relating to an eye, such as the eyelids of the eye. The estimation function 183 of the weight identifying unit 18 identifies weights w using such an identifying model. The weight identifying unit 18 may use training data and an existing identifying model to determine, in advance, weights w for calculating an optimal combined recognition score TSC. For example, the feature vectors of the iris and the feature vectors of the periocular are computed for an iris image having a vector relating to certain landmark points, the iris circle and the pupil circle. Next, a registered image of a corresponding person that has been determined in advance is identified based on a label, and two feature vectors (a feature vector of the iris and a feature vector of the periocular) are similarly extracted from this registered image. The feature vectors extracted from the image of the iris having a vector with the certain landmark points, the iris circle, and the pupil circle, and the feature vectors extracted from the registered image of the corresponding person identified based on the label are used to calculate a recognition score SC obtained by comparing the feature vectors of the iris and a recognition score SC obtained by comparing the feature vectors of the periocular. For the respective recognition scores SC that have been calculated, the weights w are estimated so as to maximize the recognition scores SC in the case of a recognition process of the correct person based on the label, and to minimize the recognition scores SC in the case of a recognition process of another person not matching the label.

The weight identifying unit 18 may directly extract a vector (landmark information) representing the state of an eye image, such as landmark points, the iris circle, and the pupil circle, used for inputting to a neural net, from an image by using a learned landmark detection model. To the vector (landmark information) indicating the landmark points, the iris circle, and the pupil circle acquired by the weight identifying unit 18, values that can be expected to relate to the weights for recognition score combination, such as the area of the iris portion, and the sizes and positions of occlusion regions caused by reflection at the surfaces of eyeglasses or by the iris surface, may be further added. In a vector (landmark information) indicating the features of an eye, such as landmark points, the iris circle, and the pupil circle, acquired by the weight identifying unit 18, the values of the respective elements may further be normalized so as to have a Gaussian distribution in which the values of the data set overall have an average of 0 and have a standard deviation of 1. Additionally, the weight identifying unit 18 may normalize the values in a dimensional direction by using the normalization function 182. The method of normalization of values is not limited to a Gaussian distribution, and normalization may be performed within a range of appropriate values as inputs to a general neural net, such as [0, 1].

The weight identifying unit 18 may calculate the weights w by using information extracted from both a vector representing the state of an eye image such as landmark points, the iris circle, and the pupil circle extracted in the recognition process and a vector representing the state of an eye image such as landmark points, the iris circle, and the pupil circle extracted in the feature vector recording process. For example, in the case in which the open/closed degree θ is used to calculate the weights w, the open/closed degree θ included in the vector extracted in the recognition process may be compared with the open/closed degree θ included in the vector extracted in the feature vector recording process, and the smaller value of the open/closed degree θ may be used to calculate the weights w by means of the process explained using FIG. 9 above. Additionally, in the case in which the iris diameter d is used to calculate the weights w, the average value of the iris diameter d included in the vector extracted in the recognition process and the iris diameter d included in the vector extracted in the feature vector recording process may be used to calculate the weights w by means of the process explained using FIG. 10 above. The vector values used for calculating the values of the weights w are not limited to average values or small values, and any operation or function may be used as long as the vector extracted in the recognition process and the two vectors extracted in the feature vector recording process are used. In the case in which a neural network is used to calculate the weights w, the network may be trained to calculate the weights w by inputting both the vectors representing the state of the eye image extracted in the recognition process and the vectors representing the state of the eye image extracted in the feature vector recording process.

The vector (landmark information) representing the state of the eye image mentioned above may include information such as the central coordinates of the iris, the radius of the iris, the diameter of the iris, the central coordinates of the pupil, the radius of the pupil, the diameter of the pupil, the position of the outer corner of the eye, the position of the inner corner of the eye, and the open/closed degree of the eyelids before normalization; the central coordinates of the iris, the radius of the iris, the diameter of the iris, the central coordinates of the pupil, the radius of the pupil, the diameter of the pupil, the position of the outer corner of the eye, the position of the inner corner of the eye, and the open/closed degree of the eyelids after normalization; the positions and areas, in the image, of occlusions due to reflected lighting, etc.; as well as information regarding the presence or absence of eyeglasses, the presence or absence of a contact lens, and the transparency/non-transparency of the contact lens; information regarding the degree of transparency of the contact lens; information regarding the presence or absence of makeup; information regarding the thickness of makeup; information regarding the presence or absence of false eyelashes; information regarding the presence or absence of mascara; etc. The weight identifying unit 18 uses detection results of these features to calculate the weights w of the recognition score SC based on the similarity of the iris and the recognition score SC based on the image including the periocular used to calculate the combined recognition score TSC. The weight identifying unit 18 may, as the method for calculating the weights of the recognition scores SC, use values determined by a person from experience, such as by changing the weight of a recognition score SC depending on the size of the iris radius. Additionally, the weight identifying unit 18 may determine the weights w for the recognition scores SC by using a regression model obtained by learning. In this case, training data including information such as iris features, periocular features, detection results, and labels may be used to train a regression model, for example, by optimizing a neural network. In this case, a regression model that takes iris detection positions as inputs and that extracts weights w of recognition scores SC as outputs is learned. The weights w that are calculated may be normalized so as to total 1.

The weights w of the respective recognition scores SC mentioned above may be calculated by a person in advance and recorded in a storage unit, etc. or set in a settings file, etc., and the weight identifying unit 18 may acquire the recorded or set weights w. Additionally, the weight identifying unit 18 may correct and update the above-mentioned weights by means of the parameter updating function 186. For example, the weight identifying unit 18 may correct or update the weights w in the case in which the diameter of the iris that is captured becomes larger or becomes smaller in accordance with the installation location of the camera of the authentication device 1.

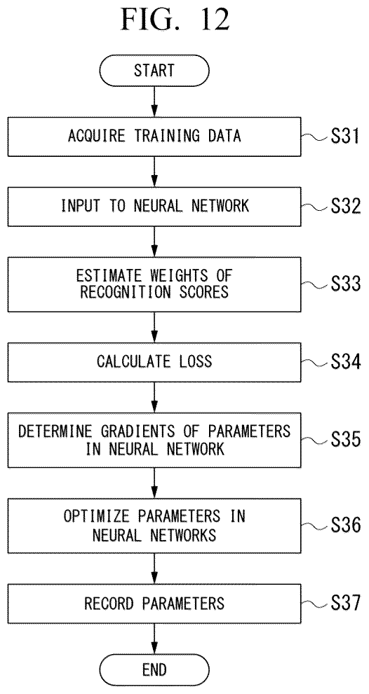

FIG. 12 is a diagram indicating the flow of the process for generating a model for identifying weights for recognition scores. The weight identifying unit 18 acquires the above-mentioned training data when learning the weight identifying model (step S31). The weight identifying unit 18 randomly extracts a predetermined number of pairs of correct information for weights and vectors representing the states of eye images, such as landmark points, iris circles, and pupil circles, from the training data, and inputs the pairs to a neural network (step S32). The size of the number is not particularly limited.

The features of the eye, such as the landmark points, the iris circle, and the pupil circle that have been input are normalized, at this time, in a manner similar to the processes in FIG. 3, FIG. 4, and FIG. 5, by means of the normalization function 182. Then, after the process of normalization (FIG. 3, FIG. 4, and FIG. 5) that has been input, using the estimation function 183, the weight identifying unit 18 uses the estimation function 183 to estimate the weight of the recognition score SC with respect to each sub-region for calculating the combined recognition score TSC, based on the vectors representing the state of the eye image, such as the landmark points, the iris circle, and the pupil circle (step S33). As long as the images are normalized in advance in the image acquisition unit 10 by the processes indicated in FIG. 3, FIG. 4, and FIG. 5, the process of normalization is unnecessary when generating the weight identifying model. Regarding the radius of the iris circle in the image, pre-normalization information may be used. The architecture of the weight identifying model for calculating the combined recognition score is not particularly limited. For example, an MLP (Multi-Layer Perceptron) having multiple layers may be used. The number of layers, the number of channels, the types of layers, etc. are not particularly limited.

The weight identifying unit 18 uses the loss function calculation function 184 to calculate the loss from the output of the neural network (step S34). As the loss, for example, the L2 distance, etc. between the estimation results and the correct answer may be used. The distance is not limited to being the L2 distance and may be anything, such as the L1 distance, the cosine similarity, etc. The weight identifying unit 18 uses the gradient calculation function 185 to determine the gradients of respective parameters of the neural network by means of, for example, error backpropagation (step S35).

The weight identifying unit 18 uses the parameter updating function 186 to optimize the parameters of the neural network by using the gradients of the respective parameters (step S36). When updating the parameters, the weight identifying unit 18 may use, for example, the stochastic gradient descent method. The weight identifying unit 18 is not limited to using the stochastic descent method as the method for optimizing the parameters in the parameter updating procedure, and aside therefrom, Adam, etc. may be used. During this process, the hyperparameters such as the learning rate, weight attenuation, and momentum are not particularly limited. In said learning, the weight identifying model is optimized by a predetermined number of repetitions (number of iterations). Hyperparameters such as the learning rate may be changed so that the learning tends to converge to a more optimal value during the optimization. Additionally, in the case in which the loss has been lowered to a certain degree, the learning may be stopped midway through. The weight identifying unit 18 records the optimized parameters (step S37).

The weight identifying unit 18 uses the model for identifying the weights w calculated in this way to calculate the weights for the recognition scores SC. That is, the weight identifying unit 18 estimates the weights w1, w2. The weight identifying unit 18 outputs the weights w1, w2 to the score combination unit 16.

The authentication device 1 described above extracts respective feature vectors from multiple regions cut out from the region of the eye of a target included in an acquired image, and identifies weights with respect to recognition scores in the case in which the recognition scores are calculated based on these feature vectors and feature vectors relating to corresponding regions pre-stored for the target. Furthermore, the authentication device 1 uses the feature vectors obtained from the respective features of the multiple regions and the weights identified with respect to those feature vectors to calculate a combined recognition score TSC for the feature vectors of the target included in the acquired image and the pre-stored feature vectors of the target. Furthermore, the authentication device 1 uses recognition scores SC weighted in accordance with the sub-region a1 and the sub-region a2 to calculate the combined recognition score TSC, and performs authentication based on the combined recognition score TSC. This combined recognition score TSC is set so that the more information there is on the iris, the larger the weight is set for the sub-region a1, in which the region of the iris is large. Thus, in the case in which the open/closed degree of the eye is large or in the case in which recognition is performed by using an image in which the iris diameter appears large, recognition is performed by emphasizing the feature vectors of the iris, and in the case in which the open/closed degree of the eye is relatively small, or in the case in which recognition is performed by using an image in which the iris diameter appears relatively small, the recognition is performed by relatively emphasizing the feature vectors of the periocular. Therefore, since recognition can be performed by emphasizing the amount of information on the iris in the case in which there is a lot of information on the iris, and conversely, recognition can be performed by emphasizing the amount of information on the periocular in the case in which there is little information on the iris, recognition can be performed in both the case in which the amount of information on the iris is high and in which it is low, thus allowing a combined recognition score TSC (similarity) to be calculated with higher performance. As a result thereof, the recognition performance of a target can be improved in recognition technology using ensemble estimation.

### Second Example Embodiment

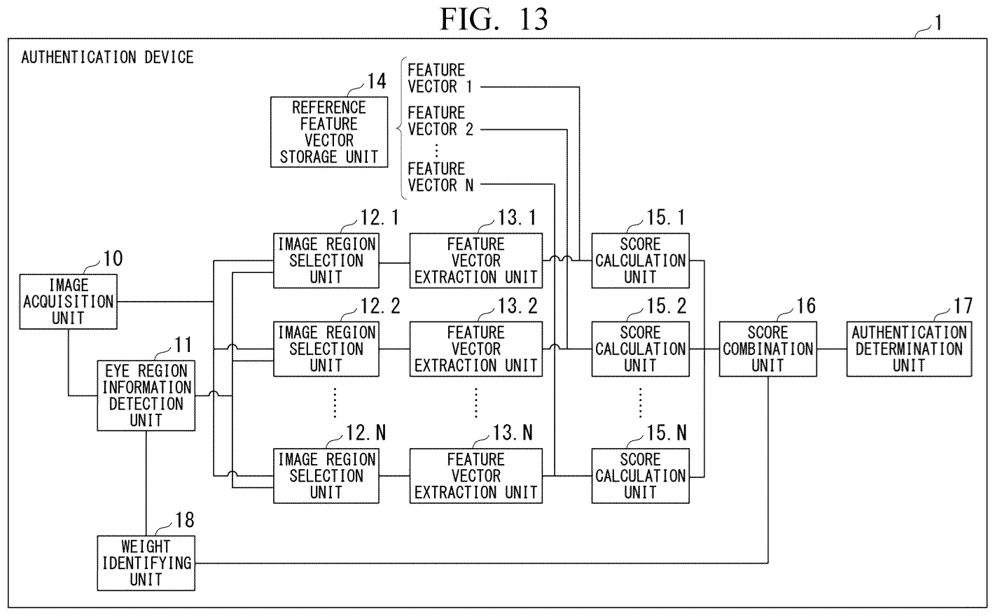

FIG. 13 is a block diagram illustrating the configuration of an authentication device 1 according to a second example embodiment.

As illustrated in FIG. 13, the authentication device 1 is provided with an image acquisition unit 10, a landmark detection unit 11, image region selection units 12.1, . . . , 12.N, feature vector extraction units 13.1, . . . , 13.N, a reference feature vector storage unit 14, score calculation units 15.1, . . . , 15.N, a score combination unit 16, an authentication determination unit 17, and a weight identifying unit 18.

The image acquisition unit 10 and the landmark detection unit 11, the reference feature vector storage unit 14, and the authentication determination unit 17 are similar to those in the first example embodiment.

The image region selection units 12.1, . . . , 12.N select multiple different sub-regions including a region of at least a portion of the iris based on the landmark information detected by the landmark detection unit 11. The image region selection units 12.1, . . . , 12.N respectively operate in parallel to select different image regions in images acquired respectively thereby. The image region selection units 12.1, . . . , 12.N may select sub-regions so as to include the iris region. One or more of the image region selection units 12.1, . . . , 12.N may select different sub-regions of the eye including a region with the entire iris. The image region selection units 12.1, . . . , 12.N will be referred to collectively as image region selection units 12.

The feature vector extraction units 13.1, . . . , 13.N extract feature vectors f relating to the sub-regions selected in the image region selection units 12. That is, the feature vector extraction unit 13.1 extracts the feature vector f1 relating to the sub-region a1 selected by the image region selection unit 12.1, the feature vector extraction unit 13.2 extracts the feature vector f2 relating to the sub-region a2 selected by the image region selection unit 12.2, and the feature vector extraction unit 13.N extracts the feature vector fn relating to the sub-region an selected by the image region selection unit 12.N. The feature vectors f are values representing features of the eye including the iris, require for performing iris recognition. The feature vector extraction units 13.1, . . . , 13.N are referred to collectively as feature vector extraction units 13.

The score calculation units 15.1, . . . , 15.N use the feature vectors f extracted by the feature vector extraction unit 13 and reference feature vectors f stored in the reference feature vector storage unit 14 to calculate a recognition score Sc for each sub-region. In other words, the score calculation unit 15.1 uses the feature vector f1 extracted by the feature vector extraction unit 13.1 and the reference feature vector f1 stored in the reference feature vector storage unit 14 to calculate a recognition score SC1 for the sub-region a1. The score calculation unit 15.2 uses the feature vector f2 extracted by the feature vector extraction unit 13.2 and the reference feature vector f2 stored in the reference feature vector storage unit 14 to calculate a recognition score SC2 for the sub-region a2. The score calculation unit 15.N uses the feature vector fn extracted by the feature vector extraction unit 13.N and the reference feature vector fn stored in the reference feature vector storage unit 14 to calculate a recognition score SCn for the sub-region an. The recognition score SC mentioned here is the similarity to a pre-registered, corresponding feature vector required for performing iris recognition. The score calculation units 15.1, . . . , 15.N are referred to collectively as score calculation units 15.

The score combination unit 16 calculates a combined recognition score TSC by using the score SC1, . . . , the score SCn obtained from the score calculation units 15.1, . . . , 15.N.

The weight identifying unit 18 calculates weights w for the recognition score SC1, . . . , the recognition score SCn.

The process in the weight identifying unit 18 involves using training data of pairs of correct weights and vectors indicating features relating to the sub-regions selected by the image region selection units 12 to generate a weight identifying model in a manner similar to the first example embodiment. The weight identifying unit 18 may use this weight identifying model to calculate weights for the score SC1, . . . , the score SCn in a manner similar to the first example embodiment.

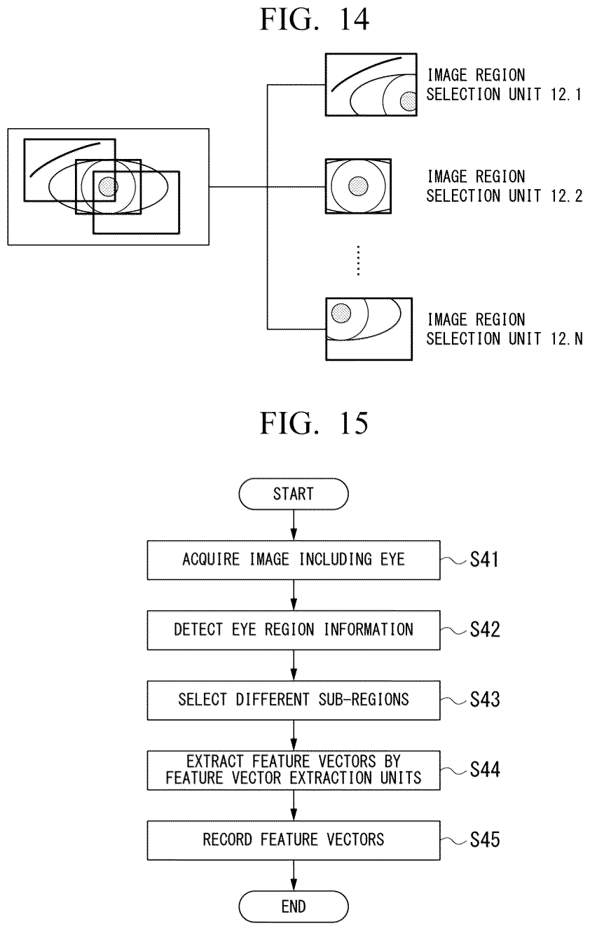

FIG. 14 is a diagram illustrating a summary of the process for selecting regions according to the second example embodiment.

The image region selection units 12, after having sequentially performed the one or more normalization processes among the processes explained by using FIG. 3, FIG. 4, and FIG. 5 above, cut out images of prescribed sub-regions based on eye feature information. As illustrated in FIG. 14, the image region selection units 12.1, . . . , 12.N can cut out images of the sub-regions at respectively different positions based on the eye feature information. The sub-regions selected by the respective image region selection units 12 may be multiple different sub-regions having different central positions. The sub-regions selected by the respective image region selection units 12 may be multiple different sub-regions in which the sizes of the selected areas are different. The respective image region selection units 12 may select multiple different sub-regions comprising sub-regions including the range of the eyeball within the regions, and sub-regions including the skin around the eyeball within the regions. The image region selection units 12 may select multiple different regions including landmark points that are set so as to allow prescribe sub-regions relating to the eye to be selected. The authentication device 1 according to the present example embodiment may use the feature vectors of images of sub-regions that differ in this way to respectively learn and generate estimation models, and may use the feature vectors in the images of the different sub-regions and the respective estimation models to perform ensemble estimation, thereby improving the recognition performance.

FIG. 15 is a diagram indicating the processing flow of a feature vector recording process performed by the authentication device 1 in the second embodiment. Next, the feature vector recording process in the authentication device 1 according to the second example embodiment will be explained with reference to FIG. 15.

During a prior feature vector recording process, the authentication device 1 inputs a facial image or a partial image of the periocular of a certain person. The authentication device 1 may use a prescribed camera to capture an image of the person, and the image generated at the time of image capture may be acquired. The image acquisition unit 10 acquires an image including the eye of the person (step S41). Said image includes at least one eye or both eyes of the person. The image acquisition unit 10 outputs the image to the landmark detection unit 11 and to the image region selection units 12.1, . . . , 12.N.

The landmark detection unit 11 detects landmark information including landmark points, etc. of the eye based on the acquired image (step S42). The process in the landmark detection unit 11 is similar to that in the first example embodiment.

To the image region selection units 12.1, . . . , 12.N, the image from the image acquisition unit 10 is input, and landmark information including landmark points, etc. from the landmark detection unit 11 are input. The image region selection units 12.1, . . . , 12.N respectively use the image and landmark information including landmark points, etc. to select different sub-regions by using a method such as that explained in FIG. 14 (step S43). The image region selection units 12.1, . . . , 12.N generate images of the selected sub-regions. The images of the sub-regions selected by the image region selection units 12.1, . . . , 12.N will be respectively referred to as images of the sub-region a1, . . . , the sub-region an. The image region selection unit 12.2 outputs the sub-region a2 to the feature vector extraction unit 13.2. Similarly, the image region selection units 12.3, . . . , 12.N output the generated images of the sub-regions to corresponding feature vector extraction units 13.

The feature vector extraction units 13.1, . . . , 13.N extract feature vectors after having performed image preprocessing such as, for example, normalization of a brightness histogram, masking processes on areas other than the iris circle, polar coordinate expansion with the center of the iris circle as the origin, and iris rubber sheet expansion using the iris circle and the pupil circle on the images of the sub-regions input from the image region selection units 12 (step S44). The feature vector extraction units 13.1, . . . , 13.N receive the images of the sub-region a1, . . . , the sub-region an as inputs from the image region selection units 12, and extract the feature vector f1, . . . , the feature vector fn. Additionally, the feature vector extraction units 13.1, . . . , 13.N may respectively use different methods to extract the feature vectors. The feature vector extraction units 13.1, . . . , 13.N may, for example, be constructed by a convolutional neural network. The feature vector extraction units 13.1, . . . , 13.N may undergo learning in advance, using the images of the sub-regions selected in the image region selection units 12.1, . . . , 12.N, so as to be able to appropriately extract feature vectors. The feature vector extraction unit 13 merely requires to be an estimator using an estimation model that can generate feature vectors with good performance, and may be another learned neural network.

Additionally, the feature vector extraction units 13.1, . . . , 13.N may be processing functions for image processing to extract feature vectors, which are not composed of neural networks.

The feature vector extraction units 13.1, . . . , 13.N record the extracted feature vector f1, . . . , feature vector fn (reference feature vectors) in the reference feature vector storage unit 14 so as to be associated with labels, etc. of people appearing in the images used in the feature vector recording process, or with labels, etc. of the feature vector extraction units 13 that extracted the feature vectors (step S45). As a result thereof, feature vectors of the eye, which are feature vectors of different sub-regions of the eye for people appearing in the images used for the feature vector recording process, are respectively recorded in the reference feature vector storage unit 14.

The authentication device 1 may perform processes similar to those described above on both the left and the right eyes appearing in an image, and may record the feature vector f1, . . . , the feature vector fn in the reference feature vector storage unit 14 so as to be further associated with a left-eye or a right-eye label. Additionally, the authentication device 1 performs similar feature vector recording processes using images of many people to whom prescribed services or processing functions are to be provided by performing authentication, and similarly records the feature vector f1, . . . , the feature vector fn in the reference feature vector storage unit 14. Due to the above processes, the description of the feature vector recording process performed in advance ends.

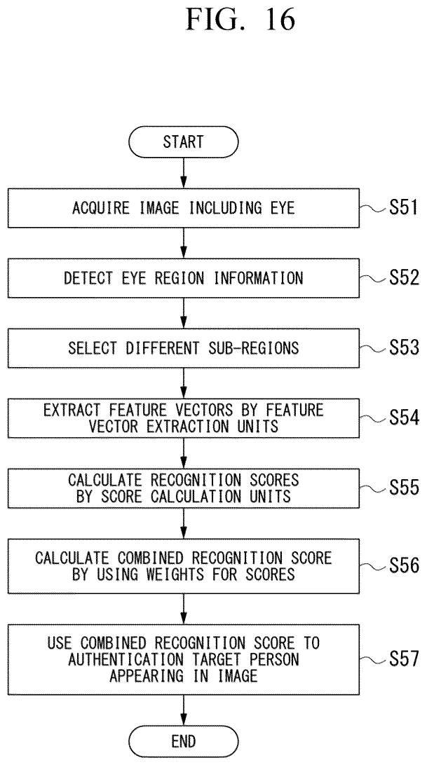

FIG. 16 is a diagram indicating the processing flow for the authentication process performed by the authentication device 1 in the second example embodiment. Next, the authentication process in the authentication device 1 of the second example embodiment will be explained with reference to FIG. 16.

During the authentication process, the authentication device 1 inputs a facial image or a partial image of the periocular of a certain person. The authentication device 1 may use a prescribed camera to capture an image of the person, and the image generated at the time of image capture may be acquired. The image acquisition unit 10 acquires an image of the eye of the person (step S51). Said image includes at least one eye or both eyes of the person. The image acquisition unit 10 outputs the image to the landmark detection unit 11 and to the image region selection units 12.1, . . . , 12.N.

The landmark detection unit 11 detects landmark information including landmark points, etc. of the eye based on the acquired image (step S52). This process is similar to the process in step S42 explained in the feature vector recording process mentioned above.

To the image region selection units 12.1, . . . , 12.N, the image from the image acquisition unit 10 is input, and landmark information including landmark points, etc. from the landmark detection unit 11 are input. The image region selection units 12.1, . . . , 12.N respectively use the image and the landmark information to select different sub-regions by using a method such as that explained in FIG. 14 (step S53). This process is similar to the process in step S43 explained in the feature vector recording process mentioned above.

The feature vector extraction units 13.1, . . . , 13.N extract feature vectors from images of the sub-regions input from the image region selection units 12 (step S54). This process is similar to the process in step S44 explained in the feature vector recording process mentioned above. The feature vector extraction units 13.1, . . . , 13.N output the feature vector f1, . . . , the feature vector fn that have been extracted to the corresponding score calculation units 15.

The score calculation units 15.1, . . . , 15.N acquire the feature vector f1, . . . , the feature vector fn respectively extracted from the corresponding feature vector extraction units 13 in the recognition process. Additionally, the score calculation units 15.1, . . . , 15.N acquire feature vectors (feature vector f1, . . . , feature vector fn) corresponding to one person extracted in the feature vector recording process recorded in the reference feature vector storage unit 14. The score calculation units 15.1, . . . , 15.N respectively use the feature vectors extracted in the recognition process and the feature vectors extracted in the feature vector recording process to calculate the recognition scores SC (step S55).

The recognition scores SC calculated by the score calculation units 15.1, . . . , 15.N will be referred to, respectively, as the score SC1, . . . , the score SCn.

The score calculation units 15.1, . . . , 15.N may calculate the score SC1, . . . , the score SCn by using, for example, the cosine similarity between the feature vectors extracted in the recognition process and the feature vectors extracted in the feature vector recording process. Additionally, the score calculation units 15.1, . . . , 15.N may calculate the recognition scores by using an L2 distance function or an L1 distance function, etc. between the feature vectors extracted in the recognition process and the feature vectors extracted in the feature vector recording process. The score calculation units 15.1, . . . , 15.N may determine whether each of the feature vectors are similar by making use of properties such as the feature vectors of data relating to the same person, such as the cosine similarity, the L2 distance function, the L1 distance function, etc. tending to be closer in distance.

The score calculation units 15.1, . . . , 15.N may be constructed, for example, by neural networks. Additionally, the score calculation units 15.1, . . . , 15.N may be functions for performing score calculation processes not composed of neural networks, and for example, may calculate the recognition scores by means of the Hamming distances between the feature vectors extracted in the recognition process and the feature vectors extracted in the feature vector recording process. The score calculation units 15.1, . . . , 15.N output the calculated recognition scores to the score combination unit 16.

The score combination unit 16 acquires the weight w1, . . . , the weight wn corresponding respectively to the score SC1, . . . , the score SCn from the weight identifying unit 18. The score combination unit 16 uses the score SC1, . . . , the score SCn, and the weight w1, . . . , the weight wn to calculate a combined recognition score TSC (step S56). Specifically, the score combination unit 16 calculates the combined recognition score TSC by using the equation “TSC=SC1*w1+ . . . +SCn*wn). In this equation, “*” represents multiplication and “+” represents addition. Additionally, the score combination unit 16 may calculate the combined recognition score SC by using an estimation method using a support vector machine or a recurrent neural network taking the scores SC1, SC2 and the weights w1, w2 as inputs. The process in the authentication determination unit 17 is similar to that in the first example embodiment.

The authentication device 1 according to the second example embodiment described above also extracts a feature vector of each of multiple regions cut out from an acquired image including the eye of a target, and identifies a weight with respect to each of recognition scores SC in the case in which the recognition scores SC are calculated based on the respective feature vectors of multiple regions and feature vectors relating to corresponding regions pre-stored for the target. Furthermore, the authentication device 1 uses the feature vector of each of the multiple regions and the weights identified with respect to those feature vectors to calculate a combined recognition score TSC for the feature vectors of the target included in the acquired image and the pre-stored feature vectors of the target. Due to this process, the authentication device 1 applies weights in accordance with the sub-regions to the recognition scores in accordance with the sub-region a1, the sub-region a2, . . . , the sub-region an to calculate the combined recognition score TSC, and performs recognition based on this combined recognition score TSC. This combined recognition score TSC is set so that the more information there is on the iris, the larger the weight of a sub-region in which the region of the iris is large. Thus, in the case in which the open/closed degree of the eye is large or in the case in which recognition is performed by using an image in which the iris diameter appears large, recognition is performed by emphasizing the feature vectors of the iris, and in the case in which the open/closed degree of the eye is relatively small, or in the case in which recognition is performed by using an image in which the iris diameter appears relatively small, the recognition is performed by relatively emphasizing the feature vectors of the periocular. Therefore, since recognition can be performed by emphasizing the amount of information on the iris in the case in which there is a lot of information on the iris, and conversely, recognition can be performed by emphasizing the amount of information on the periocular in the case in which there is little information on the iris, recognition can be performed in both the case in which the amount of information on the iris is high and in which it is low, thus allowing a combined recognition score TSC (similarity) to be calculated with higher performance. As a result thereof, the recognition performance of a target can be improved in recognition technology using ensemble estimation.

Additionally, in the authentication device 1, the image region selection units 12 select multiple different sub-regions including a region of at least a portion of the iris based on the features of an eye included in an acquired image, and the feature vector extraction unit 13 calculates the respective feature vectors of the different sub-regions. Additionally, the score calculation unit 15 calculates the respective similarities between the different sub-regions based on the relationships between the respective feature vectors of the different sub-regions and the respective feature vectors of the different sub-regions of a person that are pre-stored, and the authentication determination unit 17 performs recognition of the person whose eye is included in an acquired image based on the respective similarities of the different sub-regions. According to such a process, ensemble estimation by different estimators in accordance with different sub-regions including the iris of the eye are used to perform recognition, and therefore, the recognition performance of targets can be easily improved.

In iris recognition technology, high recognition performance is sought for actual operation. As methods for increasing recognition performance, there are methods of using focused images at higher resolutions. However, there are problems in that expensive cameras are required for acquiring images with a large number of pixels, and the constraints on the image capture environment become strict. Therefore, methods for increasing the performance by improving the information processing functions are sought. As a means for increasing the estimation performance, there is ensemble estimation. Ensemble estimation is a method that, by combining estimation results from multiple estimators, allows estimation with higher performance than the estimation results by the individual estimators. For effective ensemble estimation, the estimators must each be capable of precise estimation and the correlation of the estimation results with respect to each other must be small. In order to increase the ensemble effects in general ensemble estimation methods, random numbers are used to divide and generate the training data for generating estimation models, or estimation is performed by linking the estimators with each other. However, such methods have problems in that they require trial and error in order to increase performance and have high learning costs for the estimation models.

The authentication device 1 according to the present example embodiment, in the case in which an image including an eye has been input, extracts landmark information including landmark points, etc. set so as to be able to select prescribed sub-regions relating to the eye, and uses the obtained landmark information to select prescribed sub-regions, thereby allowing multiple sub-regions having respectively different features to be obtained without depending on the iris position in the image of the eye or the state of rotation. Since the images of these sub-regions have iris information while also including different regions, feature vectors with little correlation with respect to each other can be reliably extracted. Thus, the authentication device 1 in the present example embodiment can effectively perform ensemble estimation without performing trial-and-error using random numbers, as with general ensemble estimation methods.

FIG. 17 is a hardware configuration diagram of an authentication device.

As illustrated in this drawing, the authentication device 1 may be a computer provided with hardware such as a CPU (Central Processing Unit) 101, a ROM (Read-Only Memory) 102, a RAM (Random Access Memory) 103, a database 104, a communication module 105, etc. The functions of the authentication device 1 according to the example embodiments described above may be realized by an information processing system configured so that multiple information processing devices are provided with one or more of the functions described above and cooperate so that the overall process functions.

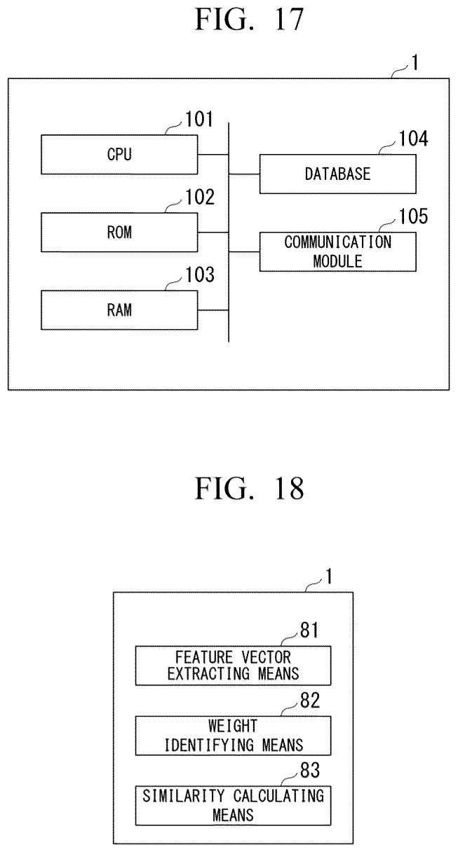

FIG. 18 is a diagram illustrating the minimum configuration of the authentication device.

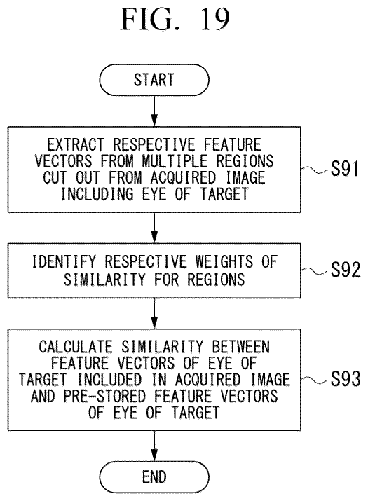

FIG. 19 is a diagram indicating a processing flow by the authentication device with the minimum configuration.

As illustrated in this drawing, the authentication device 1 provides at least the functions of a feature vector extracting means 81, a weight identifying means 82, and a similarity calculating means 83.

The feature vector extracting means 81 extracts respective feature vectors from multiple regions cut out from an acquired image including an eye of a target (step S91).

The weight identifying means 82 identifies respective weights of similarity for the regions calculated based on the feature vector of each of the multiple regions and a feature vector relating to the each of corresponding regions that are pre-stored for the target (step S92). The weights calculated for the respective regions may be normalized so as to total 1 for all of the regions.

The similarity calculating means 82 calculates the similarity between the feature vectors of the eye of the target included in the acquired image and the pre-stored feature vectors of the eye of the target, based on the feature vector of each of the multiple regions, the feature vector relating to the each of corresponding regions that are pre-stored for the target, and the weights (step S93).

The program described above may be for realizing just some of the aforementioned functions. Furthermore, it may be a so-called difference file (difference program) that can realize the aforementioned functions by being combined with a program already recorded in a computer system.

Some or all of the above-mentioned example embodiments may be described as indicated in the appendices below. However, there is no limitation to those indicated below. Additionally, the features of the respective example embodiments described above may be freely combined or modified.

### APPENDIX 1

An information processing device comprising:
feature vector extracting means for extracting a feature vector of each of multiple regions cut out from an acquired image including an eye of a target;
weight identifying means for identifying a weight of similarity for each of the multiple regions calculated based on the feature vector of each of the multiple regions and a feature vector relating to each of corresponding regions that are pre-stored for the target; and
similarity calculating means for calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

### APPENDIX 2

The information processing device according to claim 1, comprising:
detecting means for detecting landmark information indicating a position relating to the eye of the target included in the acquired image; and
image region selecting means for respectively cutting out the multiple regions based on the landmark information;
wherein the feature vector extracting means extracts the feature vector of each of the multiple regions cut out by the image region selecting means.

### APPENDIX 3

The information processing device according to claim 2, wherein:
the detecting means detects the landmark information included in the acquired image; and
the weight identifying means calculates the weight of similarity based on the landmark information.

### APPENDIX 4

The information processing device according to claim 2 or claim 3, wherein:
the weight identifying means calculates the weight of similarity based on a parameter calculated by using the landmark information.

### APPENDIX 5

The information processing device according to any one of claim 2 to claim 4, wherein:
the weight identifying means calculates the weight of similarity for each of the multiple regions based on an open/closed degree of the eye calculated based on the landmark information.

### APPENDIX 6

The information processing device according to any one of claim 2 to claim 4, wherein:
the weight identifying means calculates the weight with respect to similarity for each of the multiple regions based on pixel information for an iris of the eye calculated based on the landmark information.

### APPENDIX 7

The information processing device according to any one of claim 1 to claim 6, wherein:
the feature vector extracting means extracts a feature vector of a first region including at least a region of an iris of the eye and not including a region around the eye, and a feature vector of a second region including both the region of the iris of the eye and the region around the eye; and
the similarity calculating means calculates, using the weights identified with respect to similarity between the feature vectors obtained from each of features of the first region and the second region, and the feature vectors pre-stored for the first region and the second region, the similarity between the feature vectors of the target included in the acquired image and the pre-stored feature vectors of the target.

### APPENDIX 8

The information processing device according to claim 2 or claim 3, wherein:
the weight identifying means calculates the weight based on the landmark information and a model obtained by machine learning.

### REFERENCE SIGNS LIST

1 Authentication device (information processing device, information processing system)
10 Image acquisition unit
11 Landmark detection unit (detecting means)
12 (12.1, 12.2, . . . , 12.N) Image region selection unit (region selecting means)
13 (13.1, 13.2, . . . , 13.N) Feature vector extraction unit (feature vector extracting means)
14 Reference feature vector storage unit
15 (15.1, 15.2, . . . , 15.N) Score calculation unit (similarity calculating means)
16 Score combination unit (similarity calculating means)
17 Authentication determination unit (authenticating means)
18 Weight identifying unit (weight identifying means)

What is claimed is:

1. An information processing device comprising:
a storage medium configured to store instructions; and
a processor configured to execute the instructions to:
extract a feature vector of each of multiple regions cut out from an acquired image including an eye of a target;
identify a weight of similarity for each of the multiple regions calculated based on the feature vector of each of the multiple regions and a feature vector relating to each of corresponding regions that are pre-stored for the target; and
calculate similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

2. The information processing device according to claim 1,
wherein the processor is further configured to execute the instructions to:
detect landmark information indicating a position relating to the eye of the target included in the acquired image; and
respectively cut out the multiple regions based on the landmark information,
wherein the processor is configured to execute the instructions to:
in extracting, extract the feature vector of each of the multiple regions that are cut out.

3. The information processing device according to claim 2,
wherein the processor is configured to execute the instructions to:
in detecting, detect the landmark information included in the acquired image; and
in identifying, calculate the weight of similarity based on the landmark information.

4. The information processing device according to claim 3,
wherein the processor is configured to execute the instructions to:
in identifying, calculate the weight of similarity based on a parameter calculated by using the landmark information.

5. The information processing device according to claim 3,
wherein the processor is configured to execute the instructions to:
in identifying, calculate the weight of similarity for each of the multiple regions based on an open/closed degree of the eye calculated based on the landmark information.

6. The information processing device according to claim 3,
wherein the processor is configured to execute the instructions to:
in identifying, calculate the weight with respect to similarity for each of the multiple regions based on pixel information for an iris of the eye calculated based on the landmark information.

7. The information processing device according to claim 1,
wherein the processor is configured to execute the instructions to:
in extracting, extract a feature vector of a first region including at least a region of an iris of the eye and not including a region around the eye, and a feature vector of a second region including both the region of the iris of the eye and the region around the eye; and
in calculating, calculate, using the weights identified with respect to similarity between the feature vectors obtained from each of features of the first region and the second region, and the feature vectors pre-stored for the first region and the second region, the similarity between the feature vectors of the target included in the acquired image and the pre-stored feature vectors of the target.

8. The information processing device according to claim 3,
wherein the processor is configured to execute the instructions to:
in identifying, calculate the weight based on the landmark information and a model obtained by machine learning.

9. (canceled)

10. An information processing method comprising:
extracting a feature vector of each of multiple regions cut out from a region of an eye of a target included in an acquired image;
identifying a weight of similarity for each of the multiple regions calculated based on the feature vector of each of the multiple regions and a feature vector relating to each of corresponding regions that are pre-stored for the target; and
calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.

11. A non-transitory storage medium that stores a program for causing a computer in an information processing device to execute processes, the processes comprising:
extracting a feature vector of each of multiple regions cut out from a region of an eye of a target included in an acquired image;
identifying a weight of similarity for each of the multiple regions calculated based on the feature vector of each of the multiple regions and a feature vector relating to each of corresponding regions that are pre-stored for the target; and
calculating similarity between feature vectors of the eye of the target included in the acquired image and pre-stored feature vectors of the eye of the target, based on the feature vector of each of the multiple regions, the feature vector relating to the each of the corresponding regions that are pre-stored for the target, and weights.
